(19) United States
(12) Patent Application Publication
(10) Pub. No.: US 2026/0278875 A1
(43) Pub. Date: Sep. 17, 2026

(54) ELECTRONIC DEVICE AND METHOD

(71) Applicant: Sony Group Corporation, Tokyo (JP)

(72) Inventors: Stefan UHLICH, Stuttgart (DE); Dunai FUENTES HITOS, Stuttgart (DE); Lev MARKHASIN, Stuttgart (DE); Justinas MISEIKIS, Stuttgart (DE); Diederik Paul MOEYS, Stuttgart (DE)

(73) Assignee: Sony Group Corporation, Tokyo (JP)

(21) Appl. No.: 19/163,938

(22) PCT Filed: Mar. 27, 2024
(86) PCT No.: PCT/EP2024/058250

§ 371 Date: Sep. 10, 2025

(30) Foreign Application Priority Data
Mar. 28, 2023 (EP) 23164781.9

(51) Int. Cl. G06T 11/60

(52) U.S. Cl. CPC G06T 11/60

(57) ABSTRACT

An electronic device comprising circuitry configured to determine whether image data describes a first image that contains a second image and to determine whether an entity is not shown in the second image, the entity being a specific person, a specific animal or a specific object, and to determine whether an image of the entity should be included in the second and to modify the first image such that a modified first image of the second image includes the image of the entity.

### TECHNICAL FIELD

The present disclosure pertains to a device for modifying image data and a method for modifying image data.

### TECHNICAL BACKGROUND

There are many known methods for modifying a visual representation of an image. For physical images, known techniques include physically changing the image or producing a copy of the image that includes the desired modifications. In the case of digital images displayed on a display device, known techniques include modifying the display device or modifying the data describing the digital image. These methods require physical or mental activity on the part of a user beyond choosing the desired modification.

### LIST OF REFERENCES

Conference proceeding 1:“You Only Look Once: Unified, Real-Time Object Detection”, Joseph Redmon, Santosh Divvala, Ross Girshick and Ali Farhadi, 2016 IEEE Conference on Computer Vision and Pattern Recognition
Conference proceeding 2:“pixelNeRF: Neural Radiance Fields from One or Few Images”, Alex Yu, Vickie Ye, Matthew Tancik and Angjoo Kanazawa, CVPR 2021
Conference proceeding 3:“YOLO5Face: Why reinventing a face detector.” Qi, Delong, et al., Computer Vision-ECCV 2022 Workshops: Tel Aviv, Israel, October 23-27, 2022, Proceedings, Part V. Cham: Springer Nature Switzerland, 2023
Preprint article 1:“NIPS 2016 Tutorial: Generative Adversarial Networks”, Ian Goodfellow, arXiv: 1701.00160, version 4, submitted 3 Apr. 2017

### SUMMARY

This disclosure provides a solution for problems pertaining to modifying the visual representation of images.

There is a need for an improved technique that allows changing the visual representation of an image while preserving the image. There is a further need for an improved technique that does not require physical or mental action on the part of the user beyond choosing the desired modification. These needs are met by the present disclosure.

According to a first aspect, the disclosure, as set forth in independent claim 1, provides An electronic device comprising circuitry configured to determine whether image data describes a first image that contains a second image; and determine that an entity is not shown in the second image, the entity being a specific person, a specific animal or a specific object and determine that an image of the entity should be included in the second image and modify the first image such that a modified first image of the second image includes the image of the entity.

According to a second aspect, the disclosure, as set forth in independent claim 20, provides a method comprising determination whether image data describes a first image that contains a second image and determination that an entity is not shown in the second image, the entity being a specific person, a specific animal or a specific object and determination that an image of the entity should be included in the second image and modification of the first image such that a modified first image of the second image includes the image of the entity.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates adding a missing entity to a second image contained in a first image according to one embodiment;

FIG. 2 illustrates a method to add the missing entity to the second image to be used in AR glasses;

FIG. 3 illustrates a method to add the missing entity to the second image to be used in a VR device;

FIG. 4 illustrates a configuration of circuitry according to an embodiment of the present disclosure.

### DETAILED DESCRIPTION OF EMBODIMENTS

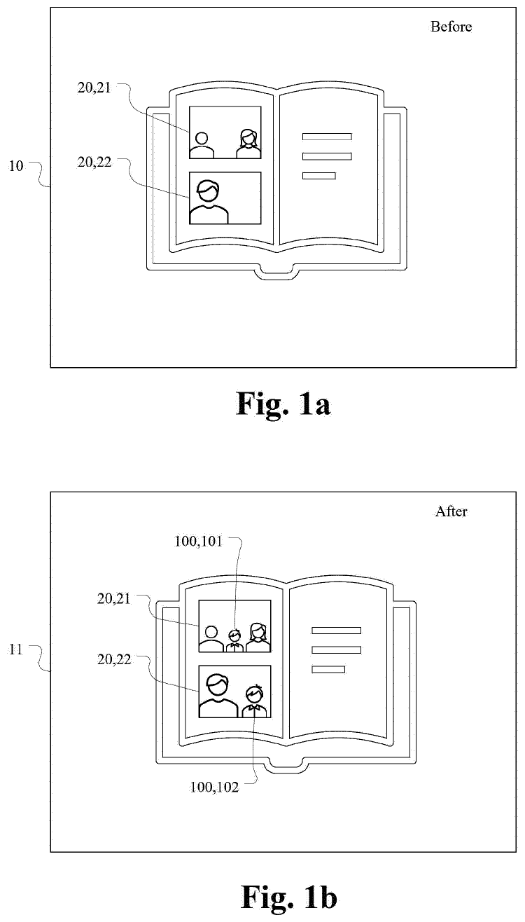

Before a detailed description of the embodiments under reference of FIG. 1 is given, general explanations are made.

Some embodiments of the present disclosure provide an electronic device comprising circuitry configured to determine whether image data describes a first image that contains a second image, and determine that an entity is not shown in the second image, the entity being a specific person, a specific animal or a specific object, and determine that an image of the entity should be included in the second image, and modify the first image such that a modified first image of the second image includes the image of the entity.

The first image can be an image as seen by a viewer or an image as captured by an imaging device. The first image can also be a sequence of images or a video sequence. The first image can be a 2D image, a 2D picture, a 3D image or a 3D scene. Image data is the data describing an image given in an appropriate data format, such as Joint Photographic Experts Group (jpeg), Portable Network Graphics (png), Graphics Interchange Format (gif), Tag Image File Format (tiff) or others. If the first image is a video sequence, the image data can be given in file formats appropriate for video processing such as Moving Pictures Experts Group-4 (mp4), Ogg video (ogg), Windows Media Video (wmv) and others. The image data can be obtained from an imaging device integrated into the circuitry, such as a camera, an event-based camera, a video capturing device or others, or from a remote or external device. The first image can contain a second image, but not all first images contain a second image. The circuitry is configured to determine whether the image data describes a first image that contains a second image or a first image that does not contain a second image. The circuitry could, for example, be implemented by a convolutional neural network which is trained in a supervised way on a dataset of first images and accompanying label information whether a first image contains a second image or not.

In the following, the term “first images” should be understood to denote one or more of a first image and the term “second images” should be understood to denote a plurality of second images.

The second image should be seen as an image depicted in a first image. The second image can be an image created at an earlier time. An image is created when, for example, the physical image is generated through a process such as printing. An image is also generated when, for example, the data describing a digital image is generated by a device such as an imaging device. A digital image can, for the purposes of the present disclosure, be a second image by being displayed by a display device in such a way that the image data describing the first image includes the digital image while it is displayed by the display device. For example, the image data describing the first image may be produced by a camera. Then a second image is any image that is included in the first image while still recognizable as an image. For example, the first image may show a book. The book can be opened to a certain page. Any image printed on that page of the book, if visible in the first image, would be the second image. Thus, the first image contains the second image but is distinct from the second image. Instead of a book, the second images can also be set in a picture frame, a placard, a poster, or any other type of physical medium. The second image can have a different dimensionality than the first image. The second image can, for example, be a 2D image or video even if the first image is a 3D image or scene. The second images can also be displayed on a television set, a computer monitor a smartphone display, a cinema screen, or any other type of display device capable of displaying a virtual or digital image. Thus, the image data describes the first image, which includes or contains the second image.

The second image may also be a drawing or a painting or a historical photograph or video. This can allow including the image of the entity into historical events or settings.

The term “determine whether a person entity is not shown in the second image” should be understood that the device determines whether or not the second image includes or contains an image of the entity. The entities not shown in the second image if the second image does not include or contain an image of the entity.

An entity can be a person, an animal, a plant or an inanimate object. In the following, the term “person” only refers to a human being. The term “object” may refer to an animal, a plant or an inanimate object.

Modification of the first image can generate a modified first image. Modification can include altering or modifying the image data of the first image. Modifying the first image may also include output of the first image such that the image of the missing entity is projected so that the user views the unmodified first image and the image of the missing entity as a composite image that is recognized as the modified first image.

The missing entity can be the user of the device or another significant person. The missing entity can also be a plurality of entities. The significant person can be any person designated by, for example, the user or automatically, such as a person known to the user personally. The significant person may also be a person generally known to the user, such as a historical personality. The image of the missing entity may be an image other than a photograph but can be a drawing of the person or an avatar, representing the person in the shape of, for example, a cat. Furthermore, instead of adding persons, the missing entity can also be objects or animals of relevance for the user, such as, for example, a dog that is the family pet.

Thus, in one embodiment, a missing entity can be introduced into a scene contained in the second image, as shown in a photo or video using AR/VR glasses. While looking at, for example, photos, an image of the user or the significant person is added to them. The user or the significant person might be displayed as a real person or as an avatar that represents the user or the significant person and which can, for example, be displayed in every second image.

Some embodiments of the present disclosure provide that the circuitry is further configured to determine whether an image of the entity should be included in the second image based on user input, or determine whether the image of the entity should be included in the second image based on user preference information, or the user preference information having a plurality of settings that can be chosen by a user, at least one of which is a default setting.

Determination of whether the image of the entity should be included in the second image can be accomplished based on user preferences, other entities detected to be shown or present in the second image or the first image, objects detected to be shown or present in the second image or based on user input. The user input can be an input to indicate that the user wishes a person or an image of the person to be included in the second image, and that causes the device to include the person or an image of the person. The user input can be obtained through an appropriate input device, such as physical buttons that may be provided on the device, voice activation or recognition, gesture control, such as analysis of hand gestures or head movement, or an electronic device that electronically transmits control signals.

Some embodiments of the present disclosure provide that the entity is a user of the device or person specified by the user or a specific animal specified by the user, or a specific object specified by the user. The user can specify a person as the entity, such as themselves or a person known to them as the entity. The user can specify an animal as the entity, such as their pet or an animal known to them as the entity. The user can specify an object as the entity, such as their house or an object known to them as the entity.

Some embodiments of the present disclosure provide that the circuitry is further configured to acquire image data. Image data can be acquired with a camera, an event-based camera, a video capturing device or any other device capable of capturing images and generating image data that can be processed by a computer. This allows the device to detect first images containing second images in a vicinity of the user in real time.

Some embodiments of the present disclosure provide that the circuitry is further configured to detect a content of an image.

Some embodiments of the present disclosure provide that the circuitry is further configured to perform object detection to detect objects as the content of the first image or as the content the second image or perform facial recognition to identify persons as the content of the first image or as the content the second image or perform object detection and facial recognition to detect persons and objects as the content of the first image or as the content of the second image.

Detection of objects and persons shown in the second image allows determination of the setting and the scene depicted in the second image.

Some embodiments of the present disclosure provide that the circuitry is further configured to perform the object detection using a machine learning approach. Object detection can, for example, make use of machine learning algorithms, deep learning and deep neural networks. The object detection can also be based on the YOLO-algorithm as presented in conference proceeding 1. For every detected object, it outputs the bounding box center (x, y), the size of the bounding box (width, height), a vector with object probabilities and, finally, a confidence value of his decision. Object recognition is a well-known procedure and any standard technique can be used.

Some embodiments of the present disclosure provide that the circuitry is further configured to perform the facial recognition using a machine learning approach. Facial recognition can make use of machine learning algorithms, deep learning, deep neural networks and facial recognition software. The scene analyzer I S2 can also be based on the YOLO-algorithm as presented in conference proceeding 1 or conference proceeding 3. Facial recognition can aid in the determination of which persons are present in the image and whether a person is missing. Facial recognition may be used, for example, to determine that a person present in the second image is a stranger. Facial recognition is a regularly performed procedure and any standard technique can be used.

Some embodiments of the present disclosure provide that the circuitry is further configured to modify image data, specifically using a machine learning approach. For example, using the bounding box of a detected face, the face of an unknown or insignificant person shown in the second image with the face image of the missing entity.

Some embodiments of the present disclosure provide that the circuitry is further configured to determine at which position the image of the person should be included in the second image based on the content of the second image. This determination can, for example, make use of machine learning algorithms, deep learning and deep neural networks. In order to facilitate this determination, the machine learning algorithm may be configured using training data. Training data may include a database comprising extensive sequences of different images, with the different images in each sequence showing persons in a specific setting. For example, one sequence may include images of different persons sitting on different benches. The machine learning algorithm can then, on the basis of the training data, determine that the second image includes a bench and then determine that the missing entity should be shown sitting on the bench. The device can be trained, for example, using an adversarial procedure. One procedure that may be used, employing two different methods, both based on convolutional neural networks, is given as an example.

The first method is a person/entity adder. The person/entity adder receives as inputs the second image as well as an image of the person/entity that should be added, which can be a third image as described hereinbelow, and outputs a modified version of the second image, which can be a modified second image, with missing person/entity inserted. The first image is then modified based on the modified second image.

The second method is a critique. The critique compares the second images generated by the person/entity adder with other pictures from the dataset and computes a probability of the input image being a real image. Using this information on probability, it is possible to train the person/entity adder. The person/entity adder can thus be configured to to add the missing person/entity at a natural place and with a natural pose and style (e.g., clothes). Additional descriptions can be found, for example, in preprint article 1.

Alternatively, a rule-based procedure can be implemented. The procedure is employed to decide that the missing entity should be added in the second image sitting on a bench that has been detected in the second image. The decision can then be made by using the rule that if a first parameter that indicates whether a bench has been detected and which can, for example, be a Boolean value, is true and a second parameter that indicates whether the bench is empty and which can, for example, be a Boolean value, is also true then the position where the missing entity is to be inserted can be the position of the bench that has been detected and found to be empty. The determination of the bench being empty can be made based on whether any bounding boxes containing faces are detected in the vicinity of the bench.

It should be understood that the bench in the above examples may also be any other object that can, in the context of an image, be interacted with, a non-exhaustive series of examples may contain a chair, a sidewalk, a streetlamp, any type of furniture, vehicles or other types of movable objects. Other procedures may be used in addition or instead of the procedure described hereinabove.

Some embodiments of the present disclosure provide that the circuitry is further configured to display image data to be displayed as an image. The image data to be displayed may be data describing the first image, the second image, an image of a missing entity or a 3D model of the modified first image, the second image or the image of the missing entity. The display may be a head mounted display (HMD), a television screen, a computer monitor, a smartphone display, or a display component of a VR device, an XR device or AR glasses. For example, a diffractive waveguide display, a holographic waveguide display, a reflective waveguide display or a virtual retinal display may be used.

Some embodiments of the present disclosure provide that the circuitry is further configured to modify the image data based on a third image. The third image may be an image of the missing entity. The third image may also be a video sequence.

Some embodiments of the present disclosure provide that the third image is modified before the image data is modified based on the third image. The third image may be modified, by changing, for example, a color, a saturation, a contrast or a content of the image before the image data is modified. The third image may be converted into a 3D object.

Some embodiments of the present disclosure provide that the circuitry is further configured to modify the image data based on the user preference information. The user preference information may, for example, specify that the missing entity should be included interacting with a certain other person. The user preference information may further specify that the image of the missing entity should fulfil certain criteria, such as an age of the missing entity as shown. The user preference information may specify that certain objects should be present in the second image, The user preference information may also specify that certain persons or objects should not be present.

Some embodiments of the present disclosure provide that the user preference information includes a list of entities. Determination of which entity is the missing entity can, for example, be based on the list of entities. For example, the user may specify that certain entities included in the list of entities should always be added to the second image. The device may also determine that, based on the list of the missing entities or previous user input, that an entity included in the list of entities should never be added or always be added or added under certain circumstances or that one entity should always replace another entity that is present in the second image.

Some embodiments of the present disclosure provide that the user preference information further includes image data of the entities included in the list of entities. The image data can, for example, be one or a plurality of images of the entities included in the list of entities. The image data can be used as the third image, for example. The device can, for example, determine that a certain image of a certain entity should be used as the third image in certain second images and another image of the missing entities should be used as the third image in other second images. The determination on which image of the missing entity should be used as the third image can, for example, be based on the content of the image of the missing entity, such as a pose of the missing entity, an age of the missing entity, a quality of the image of the missing entity or other parameters.

Some embodiments of the present disclosure provide that the circuitry is further configured to perform 2D-to-3D conversion. 2D-to-3D conversion may be accomplished, for example, using the method described in conference proceeding 2. This can be used to convert, for example the first image, which can be acquired as a 2D image, into a 3D scene by, for example, converting individual objects detected in the first image into 3D objects. The content of the second image may also be converted into at 3D model, involving conversion of images of objects detected in the second image or images of entities detected in the second image into 3D models.

Some embodiments of the present disclosure provide that the circuitry is further configured to modify the image data based on the content of the first image or based on the content of the second image. The missing entity can then be included in the image by replacing the stranger's face or image with an image of the face of the missing entity or a full image of the missing entity. An ideal location to add the image of the missing entity in the second image can also be determined. Furthermore, determination of which persons are shown or are present in the image can be used in the determination of which person is the missing entity.

Some embodiments of the present disclosure provide that the circuitry is further configured to modify the image data based on the content of the second image such that the image of the entity is seen to be interacting with a content detected in the second image. Thus, an interaction of the image of the missing entity with the persons or objects present in the second image can also be determined. The user or the entity may be shown in the background or walking through the scene in a video. This way, the user can experience the idea that the user or the entity was present at an event and watching the photos/videos can be rendered more exciting. Further, beyond determining suitable positions for the missing entity, also suitable animations or poses can be determined, such as, for example, pointing at the famous building in the second image or taking a picture of the famous building. An arrangement of the image of the entity to be included in the second image in relation to the content of the second image can also be determined. Inserting the missing person/entity in a natural way (e.g., pointing at a famous building or moving through the scene can be achieved by training the person/entity adder using an adversarial procedure as described hereinabove. For example, using a dataset with people in front of famous buildings allows the critique to learn how people behave in such locations and this information can be used to configure the person/entity adder.

Some embodiments of the present disclosure provide that the circuitry is included in a head-mounted casing to be worn by the user. However, the circuitry may also be provided in a stationary or portable electronic device or may be provided on a casing worn in locations other than the head. Head mounted casings may also be any of a virtual reality headset, augmented reality glasses or a head-mounted display. The head-mounted casing can be an electronic device, such as an Augmented-reality (AR) glasses or another AR device, or a virtual reality (VR) headset or a head mounted display (HMD).

Some embodiments of the present disclosure provide that the first image is a field of view of a user, and the image data is acquired by an image capturing device. The electronic device can be configured to capture image data using a suitable imaging device, such as a digital camera or a digital video camera. The imaging device can be provided such that the image described by the captured image data corresponds to the field of view of the user of the electronic device. The captured image data can then be image data that describes a first image according to the present disclosure.

Some embodiments of the present disclosure provide that the circuitry is further configured to pass the image data to another electronic device. Another electronic device may be a computer, a smartphone, or any other electronic device capable of receiving electronic signals. For this purpose, the circuitry may include components capable of receiving and processing a signal according to the Bluetooth standard or components capable of receiving and processing WiFi or WLAN signals. The circuitry may also be configured to access cloud data storage or the internet.

Some embodiments of the present disclosure provide a method comprising determination whether image data describes a first image that contains a second image and determination whether an entity is not shown in the second image and determination whether an image of the entity should be included in the second image based on user input, or determination whether the image of the entity should be included in the second image based on user preference information and modification of the first image such that a modified first image of the second image includes the image of the entity.

The method as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, a first image 10 before having been modified by the device according to the present disclosure may be called an unmodified first image. In the following, if not otherwise specified, the term “first image” should be understood to mean the unmodified first image 10. The label “unmodified” indicates that first image 10 shown in Fig. la is an unmodified first image 10. The unmodified first image 10 may, for example include an unmodified second image 20, or a plurality of unmodified second images 20, 21, 22. The second images 20 are shown, for example, to be included in a book. FIG. 1b shows a first image 11 after having been modified by the device according to the present disclosure. The label “modified” indicates that first image 11 shown in FIG. 1b is a modified first image 10. The first image 10 after having been modified by the device according to the present disclosure may be called a modified first image 11. Here, the unmodified first image 10 has been modified to produce the modified first image 11, such that the second image 20, 21 includes, for example, an image of a missing entity 100, 101. The image of the missing entity 100, 101 is absent from the unmodified first image 10. It should be noted that it is the first image 10 that is being modified such that the second image 20 includes the image of the missing entity 100, 101. As shown in FIG. 1b, the modified first image 11 can include a plurality of missing entities 100, 101, 102 included in a plurality of second images 20, 21, 22.

As described hereinabove, the second image 20 should be seen as an image depicted in a first image 10. For example, the first image may show, as in FIG. 1a, a book. The book can be opened to a certain page. Any image printed on that page of the book, if visible in the first image 10, would be the second image 20. Thus, the first image 10 contains the second image 20 but is distinct from the second image 20. Instead of a book, the second images 20 can also be set in a picture frame, a placard, a poster or any other type of physical medium. The second images can also be displayed on a television set, a computer monitor a smartphone display, a cinema screen or any other type of display device capable of displaying a virtual or digital image. The second images 20 may also be videos or video sequences displayed on an appropriate medium. The unmodified first image 10 can be a digital image recorded by a digital imaging or video capturing device. The unmodified first image can be composed of data stored in a data storage unit or received from an external electronic device. The modified first image 11 is an image that can be displayed by a device capable of displaying a digital image, such as a television screen, a computer monitor, a smartphone display, a virtual reality (VR) headset, an extended reality (XR) or augmented reality (AR) glasses or any other device capable. It should be noted that the modified first image 11 does not necessarily have to be a digital image. Instead, it can be an image as seen by a user wherein the image of the missing entity 100 is projected in such a way that the user views the unmodified first image 10 and the image of the missing entity 100 as a composite image that is recognized as the modified first image 11.

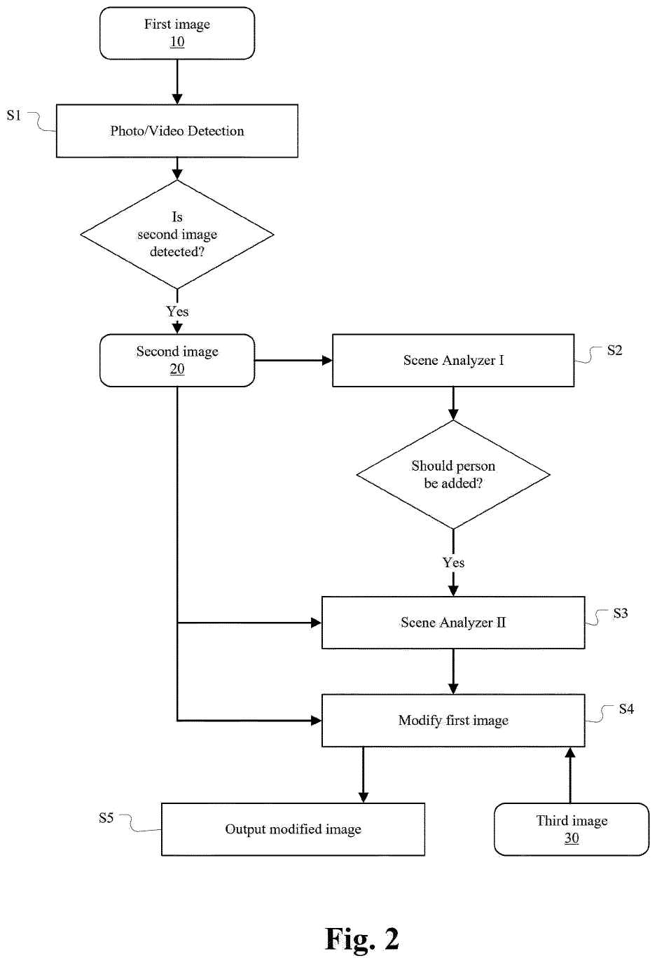

FIG. 2 illustrates a method that can be used to control the modification of the unmodified first image 10 according to one embodiment. An unmodified first image 10 is first provided, as image data, to a photo/video detector in a first step S1. The photo/video detector detects whether or not the first image 10 contains a second image 20.

In one embodiment, this may, for example, be a check whether the user is looking at a personal photo in a photo album or a personal photo or video on a television set. In this case, the image shown in the photo or photo album, personal photo or video on a television set can be called the second image 20.

If the first image 10 is found not to contain a second image 20 in step S1, the method is paused, restarted or otherwise interrupted. If the first image 10 is found to contain a second image 20, the second image is extracted. In a second step S2, the second image 20 is analyzed by a scene analyzer I. The scene analyzer I determines, based on the second image 20, whether a specific entity is missing from the second image 20 (e.g., using objection detection and face recognition techniques as well as knowledge, e. g. obtained from user input, about the specific entity) and whether the missing entity should be added to the second image 20 (e. g. based on objects detected in the second image 20 and a set of pre-specified rules). If it is determined that the entity is not missing or that the missing entity should not be added, the method is paused, restarted or otherwise interrupted. If it is determined that the entity is missing and that the missing entity should be added, the second image 20 is further analyzed in a third step S3 by a scene analyzer II. The scene analyzer II determines, based on the second image 20, where in the second image 20 the missing entity should be added. Once determined by the scene analyzer II where to add the missing entity, in a fourth step S4, the first image 10 is modified such that the second image 20 contained in the first image 10 includes an image of the missing entity. The modification step S4 can be based on the first image 10, the second image 20 and a third image 30 that contains an image of the missing entity 100. The modification of the first image 10 in the modification step S4 can result in the modified first image 11. The modified first image 11 can then be output in a fifth step S5.

It should be reiterated that the second image 20 detected in the object detection step S1 can be a video. The second image 20 detected in the object detection step S1 can be a physical picture, a digital picture on a display or a projection on, for example, a cinema screen. The object detection step S1 can make use of machine learning algorithms, deep learning and deep neural networks.

The object detection step S1 can also be based on the YOLO-algorithm as presented in conference proceeding 1.

The scene analyzer I S2 can be configured to check whether the specific entity missing from the second image 20 is a current user of the device. The scene analyzer I S2 can be configured to check whether an entity is missing and if the entity missing from the second image 20 is a specific entity other than the user or is listed on a list of significant entities. The list of significant entities can be called a list of entities. The list of specific entities can be obtained from user-input or obtained from analysis of a photo library by an external device or from a photo library provided to the device by the user. The scene analyzer I S2 can be configured to check which entity may be missing from the second image 20 based on user preference information. The user may, for example, specify an entity A as a missing entity, but that entity A should only be added to certain types of second images 20. The scene analyzer I S2 can be configured to check which entity may be missing from the second image 20 based on user preference information and the content of the second image 20. For example, the user may specify that entity A should only be added if entity B is not present. Or that entity A should only be added if entity B is also present. The scene analyzer I S2 can be configured to check if a plurality of entities should be added. The term “missing entity” can thus include more than one entity. Instead of determining that an entity should be added, the scene analyzer I S2 can be configured to generate a suggestion to add an entity which is then output to the user with an appropriate output mechanism and the method only proceeds to the scene analyzer II S3 if the user issues appropriate input. The scene analyzer I S2 can make use of machine learning algorithms, deep learning, deep neural networks and facial recognition software. The scene analyzer I S2 can also be based on the YOLO-algorithm as presented in conference proceeding 1. Determination can be based on a photo library that can be associated with the list of missing entities. For example, scene analyzer I can be realized by a convolutional neural network which receives as an input the second image and outputs which persons are missing on the photo. Such a system can be trained in a supervised way from a dataset of user images where, during training, some part of the image is masked (e.g., only one half of the image is visible to the network) and the network needs to predict which persons/entities are hidden. By this training, the network learns which image features and persons/entities condition that another person/entity should be present in the image. Instead of a scene analyzer I S2, the method can request user input that requires the user to specify whether or which entity to add to the second image 20.

The determination that an entity is missing may be implemented by using an object or facial recognition system that checks, based on a labeled sequence of pictures of an entity, provided, for example, during a training phase, whether the entity shown in the labeled sequence of pictures is present in the second image. If the check is negative, the entity is flagged as missing.

In one embodiment the scene analyzer I, for example, determines that a person as entity is missing, implemented by a face recognition and identification system which allows to determine if a significant person is not present, but others are. For example, the user may be in a photo but his girlfriend, as the missing entity, is missing. In an alternative example, the scene analyzer I determines whether the photo is a group photo where an entire family is present except the missing entity. The scene analyzer II is then used to find a suitable location to add the person. This can, for example, be accomplished by using a sequence of images as training data that are used to infer, via machine learning, how entities of the appropriate type are arranged in relation with objects detected in the training data. For example, the machine learning algorithm may be trained using sequences of images showing a busy street. A person as the missing entity can then be inserted into a second image that shows a busy street in the same arrangement inferred from the training data. Scene analyzer II can be trained from a dataset of images by first using an object detector that finds all objects (persons, entities, buildings, . . . ) in the image (i.e., finding their bounding box locations and object categories) and then asking scene analyzer II to predict the position of one of these objects if the other objects and their position are provided to it. By this training, scene analyzer II learns to place the object with respect to other objects in the image.

The scene analyzer II S3 can detect objects contained in the second image 20 and determine where, in relation to the detected objects, the missing entity should be inserted. The scene analyzer II S3 can also determine the location of the detected objects and the location of the detected persons present in the second image. The scene analyzer II S3 can then determine where, in relation to the detected objects and the detected persons, the missing entity should be included. The scene analyzer II S3 can, for example, determine that the missing entity should be included to be seen interacting with detected objects or detected persons present in the second image 20. The missing entity can, for example, be included to be seen sitting on a bench detected in the second image 20. The missing entity can, for example, be included to be seen interacting with a detected person present in the second image. The scene analyzer II S3 can further, for example, detect recognizable objects, such as famous buildings, present in the second image 20 and determine where to insert the missing entities based on the presence of these recognizable objects. The recognizable objects may also be objects that are inferred to be important to the user personally from a photo library, for example.

In one embodiment, for example, the scene analyzer II S3 checks a photo as a second image 20 and determines suitable positions where the missing entity could be added. This might be an empty park bench the missing entity is shown to be sitting on or a strange person in the picture whose face and potentially also other attributes such as clothing are replaced with the missing entity and rendered by, for example, AR glasses. The scene analyzer II S3 can, beyond determining suitable positions for the missing entity, also determine suitable animations or poses, such as, for example, pointing at the famous building in the second image 20 or taking a picture of the famous building. This can, for example, be accomplished by using a sequence of images or videos as training data that are used to infer, via machine learning, how entities of the appropriate type are arranged or move in relation with objects detected in the training data. For example, the machine learning algorithm may be trained using sequences of images or videos showing a busy street. A person as the missing entity can then be inserted into a second image that shows a busy street in the same movement inferred from the training data. According to one embodiment, the scene analyzer II S3 is configured in a supervised learning process using training data and a pose estimation network. The scene analyzer II S3 can then output pose information describing in which direction a person shown in the second image 20 is looking or which pose the person is occupying. The pose can, for example, be a hand gesture or a head gesture or a body posture or similar.

Animating the image of the missing entity, for example if the second image 20 is a video sequence, allows for better integration of the missing entity into the second image 20 and allows the missing entity to interact with persons or objects in the second image 20 which then can also interact. One could envisage an embodiment where, in a group photo, the missing entity could just arrive as last one and then makes her way to a free spot and the other people in the photo start to move slightly to make more space.

The modification step S4 generates an image of the missing entity 100 of the missing entity as determined by the scene analyzer I S2 at the location determined by the scene analyzer II S3. The image of the missing entity 100 can be based on a third image 30 provided to the device by the user. Instead of being provided by the user, the third image can also be captured by an imaging device incorporated into the circuitry. The third image 30 may also be included in a library of photos associated with the list of missing entities or included in the user preferences. The third image may also by a video sequence of the missing entity or a computed generated image or 3d-model obtained from an outside source. The third image 30 may also be a user avatar instead of a photograph. The third image may be modified to adjust for color, brightness, contrast, or content before inclusion.

According to one embodiment, the scene analyzer II S3 and the modification step S4 can be accomplished using convolutional neural networks trained in an adversarial procedure as described hereinabove.

The output step S5 may include generation of a modified image file based on the unmodified first image 10 but including the third image 30 which is then transmitted to an external electronic device, such as a television set, a computer monitor, a VR headset, a XR device or AR glasses. The circuitry may also be included in or comprise a television set, a computer monitor, a VR headset, a XR device or AR glasses or a suitable display for the modified image to be display. The modified first image 11 can also be output such that the image of the missing entity 100 is projected so that the user views the unmodified first image 10 and the image of the missing entity 100 as a composite image that is recognized as the modified first image 11.

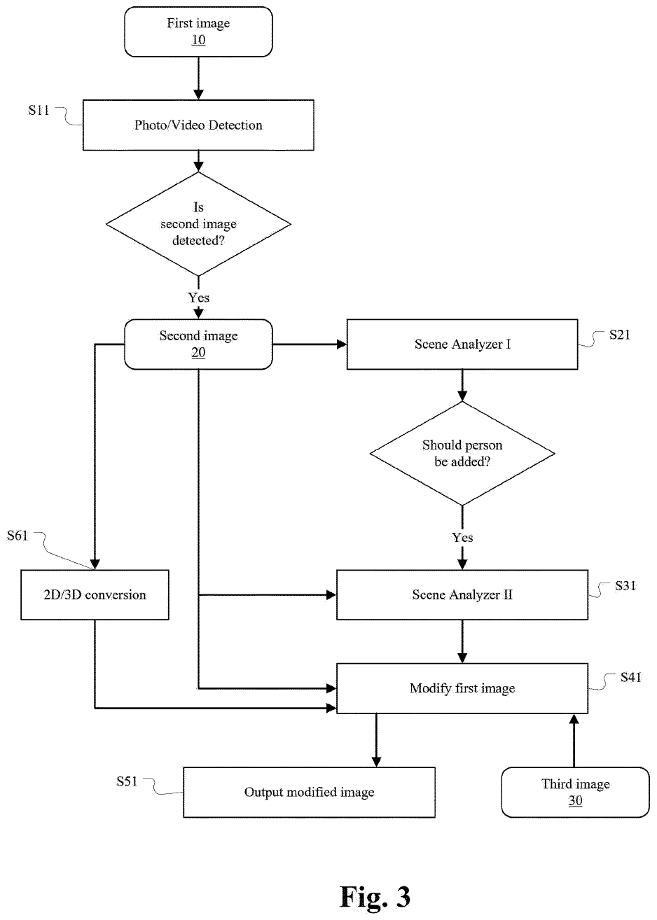

FIG. 3 illustrates a method that can be used to control the modification of the unmodified first image 10 according to one embodiment. The method illustrated in FIG. 3 can, for example, be used for VR applications. As described hereinabove, an unmodified first image 10, is first provided, as image data, to a photo/video detector in a first step S11. The photo/video detector detects whether or not the first image 10 contains a second image 20.

As described hereinabove, if the first image 10 is found not to contain a second image 20 in step S11, the method is paused, restarted or otherwise interrupted. If the first image 10 is found to contain a second image 20, the second image is extracted. In a second step S21, the second image 20 is analyzed by a scene analyzer I. The scene analyzer I determines, based on the second image 20, whether a person is missing from the second image 20 and whether the missing entity should be added to the second image 20. If it is determined that the person is not missing or that the missing entity should not be added, the method is paused, restarted or otherwise interrupted. If it is determined that the person is missing and that the missing entity should be added, the second image 20 is further analyzed in a third step S31 by a scene analyzer II. The scene analyzer II determines, based on the second image 20, where in the second image 20 the missing entity should be added. The first image 10 can, as described hereinabove, be a 2D image, a 2D picture, a 3D image or a 3D scene.

In a fourth step S61, the second image is converted from 2D to 3D. This can include converting all detected objects and all detected persons present in the second image 20 into 3D models. The second image 20 can have a different dimensionality than the first image 10. The second image can, for example, be a 2D image or video even if the first image 10 is a 3D image or scene. Once determined by the scene analyzer II where to add the missing entity, in a fifth step S41, the first image 10 is modified such that the second image 20 contained in the first image 10 includes an image of the missing entity. The modification step S41 can be based on the first image 10, the second image 20 and a third image 30 that contains an image of the missing entity 100. Here, the third image 30 can be converted from 2D into 3D and the 3D model obtained from the third image 30 is then introduced into a 3D model of the second image 20. However, there are embodiments where the third image 30 is provided as a 3D image or as a 3D model, thus obviating the conversion of the third image 30 into 3D. The modification of the first image 10 in the modification step S41 can result in the modified first image 11. The modified first image 11 can then be output, for example, by a television set, a computer monitor, a smartphone display, a VR headset, a XR device or AR glasses or others in a fifth step S51.

The 2D to 3D conversion step S61 can be accomplished using, for example, the method described in conference proceeding 2.

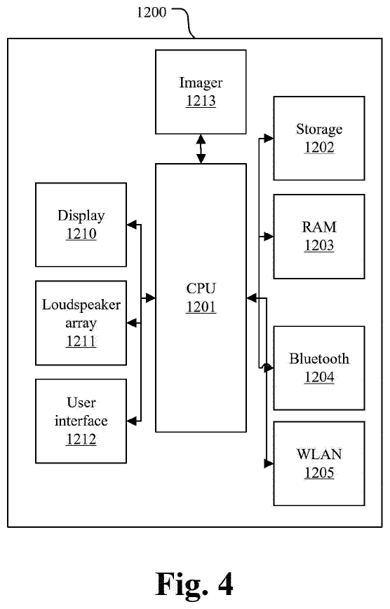

FIG. 4 illustrates the configuration of circuitry included in a device according to the present disclosure according to one embodiment. The circuitry 1200 may include a CPU 1201, a storage 1202, RAM 1203, a Bluetooth 1204 interface, WiFi or WLAN 1205, a display 1210, a loudspeaker array 1211, a user interface 1212 and an imager 1213. The CPU 1201 can be configured to execute the methods shown in FIG. 2 and FIG. 3, for example. Storage 1202 and RAM 1203 can hold the data of the first image 10 and the data generated during the execution of the methods shown in FIG. 2 and FIG. 3. The Bluetooth 1204 interface can include a required hardware and software, as well as a transmitter and a receiver. The WiFi or WLAN 1205 can include a required hardware and software, as well as a transmitter and a receiver. Both Bluetooth 1204 and WLAN 1205 can be used to transmit and receive data. The display 1210 can be a television set, a computer monitor, a smartphone display, a VR headset, a XR device or AR glasses or others or the display devices included in a television set, a computer monitor, a smartphone display, a VR headset, a XR device or AR glasses or others. The loudspeaker array 1211 can be used to output audible signals indicating the state of the device to the user. The loudspeaker array 1211 can be used to output audible signals indicating the state of the methods according to the present disclosure to the user. The user interface 1212 can, for example, be used to provide user input to the device. The imager 1213 can be used to acquire images such as, for example, the first image 10 or the third image 30.

The circuitry 1200 can be included or provided in another electronic device. The circuitry can further utilize components of that device already present as any of the CPU 1201, the storage 1202, the RAM 1203, the Bluetooth 1204 interface, the WiFi or WLAN 1205, the display 1210, the loudspeaker array 1211, the user interface 1212 or the imager 1213. Any of the CPU 1201, the storage 1202, the RAM 1203, the Bluetooth 1204 interface, the WiFi or WLAN 1205, the display 1210, the loudspeaker array 1211, the user interface 1212 or the imager 1213 may also be accessed remotely. The circuitry can omit certain components described here. For example the display 1210, the loudspeaker array 1211, the user interface 1212, the imager 1213 or others may be omitted from the circuitry.

It should be recognized that the embodiments describe methods with an exemplary ordering of method steps. The specific ordering of method steps is however given for illustrative purposes only and should not be construed as binding. For example, the ordering of S41 and S61 in the embodiment of FIG. 3 may be exchanged. Other changes of the ordering of method steps may be apparent to the skilled person.

Please note that the division of the method into units scene analyzer I and scene analyzer II is only made for illustration purposes and that the present disclosure is not limited to any specific division of functions in specific units. For instance, the scene analyzer I could be implemented by a respective programmed processor, field programmable gate array (FPGA) and the like.

The method can also be implemented as a computer program causing a computer and/or a processor, such as the CPU 1200 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
p (1) An electronic device comprising circuitry 1200 configured to determine whether image data describes a first image 10 that contains a second image 20; and determine whether a entity is not shown in the second image 20; the entity being a specific person, a specific animal or a specific object; and determine whether an image of the entity should be included in the second image; and modify the first image 10 such that a modified first image 11 of the second image 20 includes the image of the entity.
(2) The electronic according to (1), the circuitry 1200 being further configured to determine whether an image of the entity should be included in the second image 20 based on user input, or determine whether the image of the entity should be included in the second image 20 based on user preference information, the user preference information having a plurality of settings that can be chosen by a user, at least one of which is a default setting.
(3) The electronic device according to any of (1) or (2), the entity being a user of the device or person specified by the user or a specific animal specified by the user or a specific object specified by the user.
(4) The electronic device according to any of (1) to (3), the circuitry 1200 being further configured to acquire image data.
(5) The electronic device according to any of (1) to (4), the circuitry 1200 being further configured to detect a content of an image.
(6) The electronic device according to any of (1) to (5), the circuitry 1200 being further configured to perform object detection to detect objects as the content of the first image 10 or as the content the second image 20; or perform facial recognition to detect persons as the content of the first image 10 or as the content the second image 20; or perform object detection and facial recognition to detect persons and objects as the content of the first image 10 or as the content the second image 20, and determine whether the image of the entity should be included in the second image 20 based on the content of the second image 20; and/or determine whether the image of the entity should be included in the second image 20 based on the content of the first image 10.
(7) The electronic device according to any of (1) to (6), the circuitry 1200 being further configured to perform the object detection using a machine learning approach.
(8) The electronic device according to any of (1) to (7), the circuitry 1200 being further configured to perform the facial recognition using a machine learning approach.
(9) The electronic device according to any of (1) to (8), the circuitry 1200 being further configured to modify image data.
(10) The electronic device according to any of (1) to (9), the circuitry 1200 being further configured to modify the image data using a machine learning approach.
(11) The electronic device according to any of (1) to (10), the circuitry 1200 being further configured to determine at which position the image of the entity should be included in the second image 20 based on the content of the second image 20.
(12) The electronic device according to any of (1) to (11), the circuitry 1200 being further configured to determine at which position the image of the entity should be included in the second image 20 using a machine learning approach.
(13) The electronic device according to any of (1) to (12), the circuitry 1200 being further configured to display the image data to be displayed as an image.
(14) The electronic device according to any of (1) to (13), the circuitry 1200 being further configured to modify the image data based on a third image 30.
(15) The electronic device of any of (1) to (14), wherein the third image 30 is an image of an entity.
(16) The electronic device according to any of (1) to (15), the third image 30 being is modified before the image data is modified based on the third image 30.
(17) The electronic device according to any of (1) to (16), the circuitry 1200 being further configured to modify the image data based on the user preference information.
(18) The electronic device according to any of (1) to (17), the user preference information including a list of entities.
(19) The electronic device according to any of (1) to (18), the user preference information further including image data of the entities included in the list of entities.

(20) The electronic device according to any of (1) to (19), the circuitry 1200 being further configured to perform 2D-to-3D conversion.
(21) The electronic device according to any of (1) to (20), the circuitry 1200 being further configured to modify the image data based on the content of the first image 10 or based on the content of the second image 20.
(22) The electronic device according to any of (1) to (21), the circuitry 1200 being further configured to modify the image data based on the content of the second image 20 such that the image of the entity is seen to be interacting with a content detected in the second image 20.
(23) The electronic device according to any of (1) to (22), the circuitry 1200 being included in a head-mounted casing.
(24) The electronic device according to any of (1) to (23), the circuitry 1200 being included in any of a virtual reality headset, augmented reality glasses or a head-mounted display.
(25) The electronic device according to any of (1) to (24), the first image 10 being a field of view of a user; and the image data being acquired by an image capturing device.
(26) The electronic device according to any of (1) to (25), the circuitry 1200 being further configured to pass the image data to another electronic device.
(27) A method comprising: determine whether image data describes a first image 10 that contains a second image 20; and determine whether an entity is not shown in the second image 20; the entity being a specific person, a specific animal or a specific object; and determine whether an image of the entity should be included in the second image 20; and modify the first image 10 such that a modified first image 11 of the second image 20 includes the image of the entity.
(28) A computer program comprising program code causing a computer to perform the method according to any of (2) to (25), when being carried out on a computer.
(29) A non-transitory computer-readable recording medium that stores therein a computer program product, which, when executed by a processor, causes the method according to anyone of (2) to (25) to be performed.

### LIST OF REFERENCE SIGNS

10 First image
11 Modified first image
20 Second image
21, 22 Second image
100 Image of the missing entity
101, 102 Image of the missing entity
1200 Circuitry
1201 CPU
1202 Storage
1203 RAM
1204 Bluetooth
1205 WLAN
1210 Display
1211 Loudspeaker array
1212 User interface
1213 Imager

1. An electronic device comprising circuitry configured to:
determine whether image data describes a first image that contains a second image; and
determine that an entity is not shown in the second image;
the entity being a specific person, a specific animal or a specific object; and
determine that an image of the entity should be included in the second image; and
modify the first image such that a modified first image of the second image includes the image of the entity.

2. The electronic device of claim 1, the circuitry being further configured
to determine whether an image of the entity should be included in the second image based on user input;
or determine whether the image of the entity should be included in the second image based on user preference information; or
the user preference information having a plurality of settings that can be chosen by a user, at least one of which is a default setting.

3. The electronic device of claim 1, the entity being a user of the device or person specified by the user or a specific animal specified by the user or a specific object specified by the user.

4. The electronic device of claim 1, the circuitry being further configured to detect a content of an image.

5. The electronic device of claim 4, the circuitry being further configured to
perform object detection to detect objects as the content in the first image or as the content of the second image; or
perform facial recognition to detect specific persons as the content of the first image or as the content the second image; or
perform object detection and facial recognition to detect persons and objects as the content the second image; and
determine whether the image of the entity should be included in the second image based on the content of the second image; and/or
determine whether the image of the entity should be included in the second image based on the content of the first image; and/or
determine at which position the image of the entity should be included in the second image based on the content of the second image.

6. The electronic device of claim 5, the circuitry being further configured to perform the object detection and/or the facial recognition using a machine learning approach.

7. The electronic device of claim 1, the circuitry being further configured to modify image data.

8. The electronic device of claim 7, the circuitry being further configured to modify the image data using a machine learning approach.

9. The electronic device of claim 5, the circuitry being further configured to determine at which position the image of the entity should be included in the second image using a machine learning approach.

10. The electronic device of claim 1, the circuitry being further configured to display the image data to be displayed as an image.

11. The electronic device of claim 1, the circuitry being further configured to modify the image data based on a third image.

12. The electronic device of claim 11, wherein the third image is an image of an entity.

13. The electronic device of claim 12, the third image being modified before the image data is modified based on the third image.

14. The electronic device of claim 1, the circuitry being further configured to
modify the image data based on the user preference information; or
modify the image data based on the content of the first image or based on the content of the second image.

15. The electronic device of claim 1, the user preference information including
a list of entities that includes entities; and
image data of the entities included in the list of entities.

16. The electronic device of claim 1, the circuitry being further configured to perform 2D-to-3D conversion.

17. The electronic device of claim 5, the circuitry being further configured to modify the image data based on the content of the second image such that the image of the entity is seen to be interacting with a content detected in the second image.

18. The electronic device of claim 1, the circuitry being included in any of a virtual reality headset, augmented reality glasses or a head-mounted display.

19. The electronic device of claim 18,
the first image being a field of view of a user; and
the image data being acquired by an image capturing device.

20. A method comprising:
determine whether image data describes a first image that contains a second image; and
determine that an entity is not shown in the second image;
the entity being a specific person, a specific animal or a specific object; and
determine that an image of the entity should be included in the second image; and
modify the first image such that a modified first image of the second image includes the image of the entity.
